(19) United States
(12) Patent Application Publication
(10) Pub. No.: US 2005/0275679 A1
(43) Pub. Date: Dec. 15, 2005

(54) Removing gas from a printhead

(76) Inventors: Ashley E. Childs, Corvallis, OR (US); Daniel Stirn, Albany, OR (US); Harold F. Mantooth, Vancouver, WA (US); Kit L. Harper, Vancouver, WA (US); Donald L. Michael, Monmoth, OR (US); Ian P. Anderson, Portland, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/172,754

(22) Filed: Jun. 30, 2005

Related U.S. Application Data
(63) Continuation-in-part of application No. 10/769,422, filed on Jan. 30, 2004.

(51) Int. Cl. B41J 2/165

(52) U.S. Cl. 347/25

(57) ABSTRACT

A method of removing gas from a printhead that includes a plurality of orifices configured to receive ink from a supply conduit through passages extending from the supply conduit to the plurality of orifices. The plurality of orifices are sealed from external the printhead to restrict passage of fluid through the orifices. Ink is moved along the supply conduit and through an outlet of the supply conduit disposed downstream of the passages, with the plurality of orifices sealed, so that ink displaces gas from the supply conduit.

### CROSS-REFERENCE TO RELATED APPLICATION

This is a continuation-in-part of copending application Ser. No. 10/769,422 filed on Jan. 30, 2004, which is hereby incorporated by reference.

### BACKGROUND

Printers may create printed output on a print medium by firing ink droplets at the print medium from nozzles of a printhead. Ink for the droplets may be supplied by an ink reservoir in communication with the nozzles via a fluid architecture in the printhead. To prepare the printhead for firing, the printhead may need to be primed with ink, to remove gas from the fluid architecture, so that an uninterrupted supply of ink can flow from the ink reservoir to the nozzles.

### BRIEF DESCRIPTION OF THE DRAWINGS

FIG. 1 is a view of an embodiment of a printer configured for removal of gas from printheads of the printer by sealing orifices of the printheads, in accordance aspects of the present teachings.

FIG. 2 is a schematic view of the printer of FIG. 1, in accordance with aspects of the present teachings.

FIG. 3 is a sectional view of a printhead assembly from the printer of FIG. 1.

FIG. 4 is a fragmentary sectional view of a printhead of the printhead assembly of FIG. 3, taken generally along line 4-4 of FIG. 3.

FIG. 5 is a fragmentary sectional view of the printhead of FIG. 4, taken generally along line 5-5 of FIG. 4.

FIG. 6 is a fragmentary sectional view of the printhead of FIG. 5 in an unprimed configuration, in accordance with aspects of the present teachings.

FIG. 7 is a fragmentary sectional view of the printhead of FIG. 5 during sealing of orifices of the printhead from external the printhead, in accordance with aspects of the present teachings.

FIG. 8 is a fragmentary sectional view of the printhead of FIG. 5 after movement of ink through a supply conduit of the printhead while the orifices of the printhead are sealed, in accordance with aspects of the present teachings.

FIG. 9 is a fragmentary sectional view of the printhead of FIG. 5 in a fully primed condition after gas has been replaced substantially by ink in the supply conduit and passages from the supply conduit to the orifices, in accordance with aspects of the present teachings.

FIG. 10 is a fragmentary sectional view of the printhead of FIG. 5 firing droplets from one of its orifices after replacement of internal gas with ink, in accordance with aspects of the present teachings.

### DETAILED DESCRIPTION

The present teachings provide systems, including methods and apparatus, for removing gas from a printhead. The printhead may include a plurality of orifices (nozzles) from which ink can be expelled from the printhead. The printhead also may include a supply conduit that supplies ink to the orifices from an ink reservoir. The supply conduit may have an inlet and an outlet. The supply conduit may be connected to the orifices via a fluid architecture that has passages extending from the supply conduit at positions intermediate the inlet and the outlet of the supply conduit.

The methods may include sealing the orifices and moving ink through the supply conduit. Sealing and moving may be performed at any suitable time, generally though after shipping and/or when the printhead has become deprimed through lack of use. For example, sealing and moving may be initiated, in some cases automatically, before the printhead ever has been used to print to media and/or after the printhead has been idle for a predefined time period and, optionally, after a print command has been received. Furthermore, sealing and moving may be performed to prime a deprimed printhead even when the orifices are dry and vented to the atmosphere outside the printhead.

The orifices may be sealed, for example, by application of a sealing material to the printhead from external the printhead. The sealing material may restrict passage of fluid through the sealed orifices, such as inward passage of air through the orifices that would introduce additional gas into the printhead. The sealing material may be a solid sealant to provide a mechanical sealing mechanism or a liquid sealant, such as water, ink, and/or a glycol, among others. In some examples, the sealing material may have a surface tension that provides a bubble pressure across the orifices that is greater than the pressure drop of ink through the conduit from the reservoir. In some examples, the pressure differential necessary to pull ink down to the nozzles may be less than about ten inches of water, whereas the bubble pressure at the orifices may be approximately thirty inches of water.

Ink may be moved through the supply conduit to its outlet with the orifices sealed, to displace gas in the supply conduit with ink. The sealed orifices thus may restrict an inward flow of external gas (such as air) through the orifices, which may occur otherwise without the orifices sealed, as a result of a pressure drop generated across the orifices. The displacement of gas from the conduit may promote and/or effect priming of the printhead with ink.

The apparatus may include a printing device such as an inkjet printer. The printing device may include a sealing mechanism that seals the orifices of the printhead. The sealing mechanism may be, for example, an applicator configured to apply a sealant to orifices of a printhead, by contact or noncontact mechanisms. The printing device further may include a flow controller configured to move ink through the conduit of the printhead. The printing device may be configured to remove the sealant after the conduit has been primed with ink, for example, mechanically and/or by firing ink from the orifices (such as into a spittoon), among others. The printhead may include a print position and a service position in the printing device, and the sealing mechanism (and/or sealant removal) may be disposed (and/or performed) in the service position.

The methods and apparatus disclosed herein may provide a more economical and/or effective approach to priming printheads and/or removing gas from the printheads. For example, the methods and apparatus disclosed herein may waste substantially less ink than a vacuum applied to the printhead orifices from external the printhead, which can suck substantial quantities of wasted ink from the printhead as the vacuum removes gas from the printhead. In addition, the methods and apparatus may allow the use of a smaller and/or quieter pump and/or may overcome problems associated with nozzle seals, such as tape, that generally are not reusable.

Gas, as used herein, may include air and/or any gas-phase substance or mixture disposed in or adjacent the printhead and/or the ink. Accordingly, gas may be introduced into an ink supply during packaging of the ink or fabrication of the printhead, may diffuse through the ink cartridge walls from the ambient environment, may escape from a dissolved condition or by evaporation, and/or may enter from an opening in the ink supply or printhead, such as air entering through an ink supply chamber, an ink reservoir, and/or a printhead nozzle, among others.

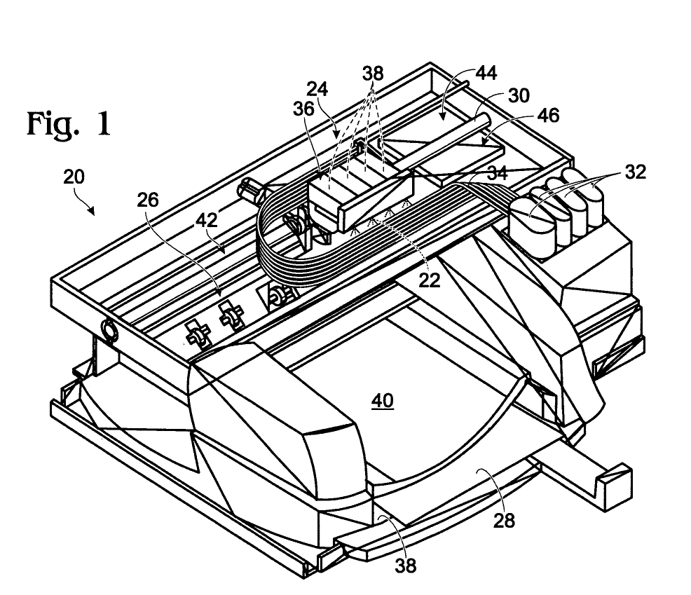

FIG. 1 shows an embodiment of a printer 20 configured for removal of gas from printheads 22 of the printer after application of a sealing material to the printheads. Printer 20 may be any suitable type of printing device that delivers colorant(s) to media, such as an inkjet printer, among others. Printer 20 may include a colorant application assembly 24 and a media movement mechanism 26.

Colorant application assembly 24 may be configured to dispense one or more flowable colorants, hereafter termed ink, from printheads 22 to selected positions of a print medium 28, such as paper. Each printhead may include orifices (nozzles) and firing elements, such as heaters or piezoelectric elements, disposed adjacent the orifices. The printheads may be configured to reciprocate on carriage rod 30 to dispense swaths of ink to the selected positions of the print medium. The colorant application assembly may include a plurality of ink reservoirs 32 holding ink of different colors and in fluid communication with printheads 22. The ink reservoirs may be disposed adjacent the printheads as part of a cartridge and movable on the carriage rod during printhead scanning along a scan axis, for on-axis supply of ink. Alternatively (or in addition), as shown in the present illustration, the ink reservoirs may be spaced from the printheads, for example, connected thereto using supply tubing 34. Accordingly, in some embodiments, the ink reservoirs 32 may be stationary as the printheads reciprocate on carriage rod 30.

In the off-axis configuration shown in the present illustration, each printhead may be included in a printhead assembly 36 including an ink supply chamber 38. Each supply chamber may receive ink for its respective printhead from a corresponding ink reservoir 32 using supply tubing 34.

Media movement mechanism 26 may be configured to move a print medium before, during, and/or after colorant application assembly 24 dispenses ink onto the print medium. The media movement mechanism may define a path of media travel, from an input site 38 to an output site 40, with the path disposed orthogonally to a scan axis along which the printheads reciprocate. The printheads may be configured to reciprocate in a print zone 42 adjacent the print medium for dispensing ink to the print medium. The printheads also may travel to a service zone 44 separate from, or overlapping, the print zone and including a service station 46, as described in more detail below.

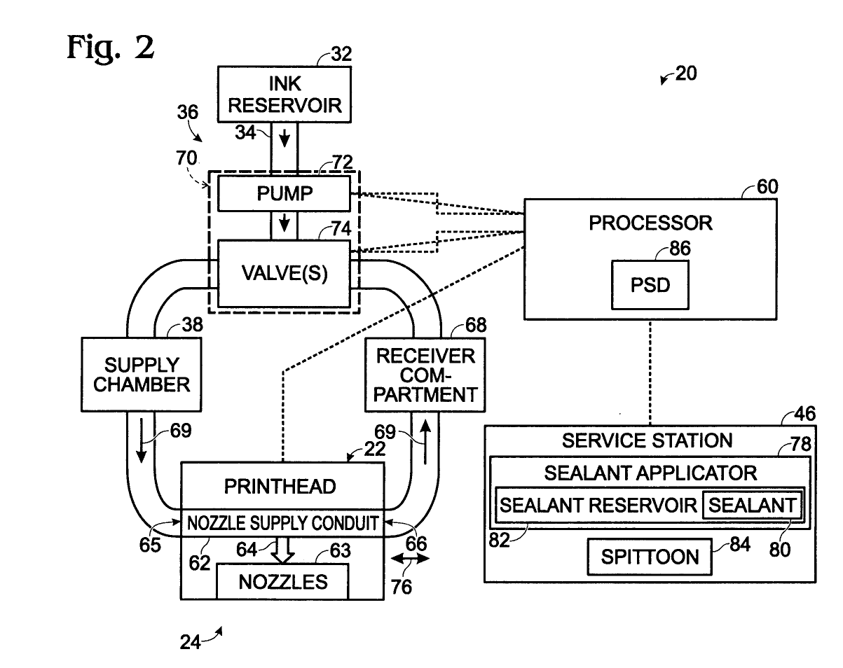

FIG. 2 shows a schematic representation of selected aspects of printer 20. Printer 20 may include colorant application mechanism 24, a service station 46 for servicing and/or storing aspects of the colorant application mechanism, and a processor (and/or a controller) 60 for controlling operation of the colorant application mechanism and/or service station.

Colorant application mechanism 24 may be configured to move ink between one or more ink reservoirs 32 and one or more printheads 22. To simplify the presentation, a single ink reservoir and printhead are shown in the present illustration. The ink reservoir may supply ink to printhead assembly 36 through channel 34. The ink may travel from the ink reservoir to supply chamber 38 of the printhead assembly and then to a supply conduit 62 of the printhead. The supply conduit may supply ink to nozzles 63 of the printhead via a fluid architecture of passages 64 that provide fluid communication between the supply conduit and the nozzles. The passages may extend from the supply conduit at positions downstream of an inlet 65 of the supply conduit and upstream of an outlet 66 of the supply conduit, with the inlet and outlet being distinct in structure and disposition from the nozzles. Accordingly, ink from the supply chamber to the supply conduit and then to the nozzles and/or may travel past outlet 66 to receiver compartment 68, as indicated by the arrows shown at 69 (or in reverse, from receiver compartment 68 to supply chamber 38 and/or nozzles 63, among others).

Colorant application mechanism 24 may include at least one flow controller 70 to control fluid movement within the colorant application mechanism. The flow (or pressure) controller may include a pump 72 (or pumps). The pump may be any mechanism for exerting a pressure on ink directly, or on a container holding ink, including pressurized gas, a vacuum pump, a mechanical pump (syringe, rotary, peristaltic, etc.), a biasing element (such as a spring), and/or the like. The pump may be disposed in the service station or outside of the service station. The flow controller also or alternatively may include one or more valves 74 operable to permit or restrict fluid movement between ink compartments.

Service station 46 may be any portion of the printer configured to service and/or store printhead 22. The service station may be substantially stationary, so that the printhead is moved to the service station, the service station may move to the printhead, or a combination thereof, as indicated at 76. Service station 46 may include a sealant applicator 78 configured to apply a sealant or sealing material 80 to the printhead from sealant reservoir 82. In some examples, the applicator may be a wiper (such as a wiper blade) that receives a sealing fluid from the sealant reservoir by capillary action. Service station 46 also may include a waste reservoir or spittoon 84 to receive ink and/or sealant from the printhead, particularly ink and/or sealant ejected from the printhead by actuation of firing elements of the printhead.

The sealant or sealing material may be solid, liquid, or a combination thereof (such as a gel), among others. A solid sealing material may include a resilient member, such as formed of plastic or rubber, which engages the printhead surface to create a seal. A liquid sealing material may be any suitable liquid. The sealing material may have a burst pressure less, than, about the same as, or greater than the burst pressure of ink in the printhead. The “burst pressure” for a fluid, as used herein, is the pressure at which the fluid's sealing capacity is lost, in this case, the pressure at which a fluid sealing an orifice permits entry of external gas through the orifice. The burst pressure is related to the surface tension of the fluid. Accordingly, the sealing material may have a surface tension that provides a burst pressure greater than the pressure produced across the orifices by operation of the flow controller. In some examples, the sealing material may be soluble in ink and may be miscible with the ink, that is, soluble at any ratio of sealing material to ink. Exemplary sealing materials may be water, ink, alcohols, particularly polyols or diols, such as glycols or polymers thereof. Exemplary glycols or glycol polymers that may be suitable include glycerol, dipropylene glycol, ethylene glycol, propylene glycol, and/or polyethylene glycol, among others.

The sealant applicator may be any sealing mechanism for applying sealant 80 to the printhead. The form of the applicator may be in accordance with the type of sealant used. For example, with a solid sealant, the sealant applicator may be a structure or device for placing the solid sealant against the printhead, such as a cantilever or spring, among others. With a liquid sealant, the sealant applicator may be a structure that spreads the liquid sealant, such as a pad, brush, or wiper, among others. Alternatively, or in addition, the sealant applicator may be a structure configured to spray the sealant on the printhead, to dip the printhead into the sealant, and/or the like. The sealant applicator and/or sealing mechanism thus may seal orifices of the printhead with or without contact between the applicator/sealing mechanism and the printhead.

Processor 60 may be any controller included in the printer or disposed in a separate apparatus, such as a computing device in communication with the printer. The processor may include a program storage device (PSD) 86, such as memory, to store instructions for controlling operation of the printer. The processor may be configured to control operation of pump 72 and valve(s) 74, such as controlling when and how much ink flows from ink reservoir 32 (and/or supply chamber 38) to printhead assembly 36. The processor also may be configured to control when and how much sealant 80 is applied to the printhead and to coordinate application of sealant and movement of ink through nozzle supply conduit 62. Accordingly, the processor may be coupled to a sensor that senses a property of ink from a subset or all of the nozzles. For example, the sensor may measure a property such as droplet size, droplet trajectory, and/or presence/absence of ink or fired droplets. Data from the sensor may be processed by the processor to determine when the printhead should be serviced to remove gas from the conduit and thus prime the nozzles. Accordingly, the processor may be configured to automatically initiate application of the sealing material and/or movement of ink through the supply conduit to the receiver compartment based on the sensor data. Alternatively, or in addition, the processor may be configured to initiate removal of gas from printheads at predefined intervals or based on instructions received from a user through a user interface. For example, the processor may be configured to initiate sealing orifices and/or moving ink through the supply conduit after the printhead has been idle (has not fired ink) for a predefined idle time. The predefined idle time may be preset during manufacture, installation, and/or may be input by a user, among others. Any suitable idle time may be used, such as greater than about one, two, four, or six weeks, among others. In some examples, the processor also may wait for a print command before sealing and moving are initiated automatically. The processor further may be configured to control removal of the sealing material from the printhead, such as by spitting ink from the printhead, and to coordinate this removal with movement of ink through the supply conduit after application of the sealing material.

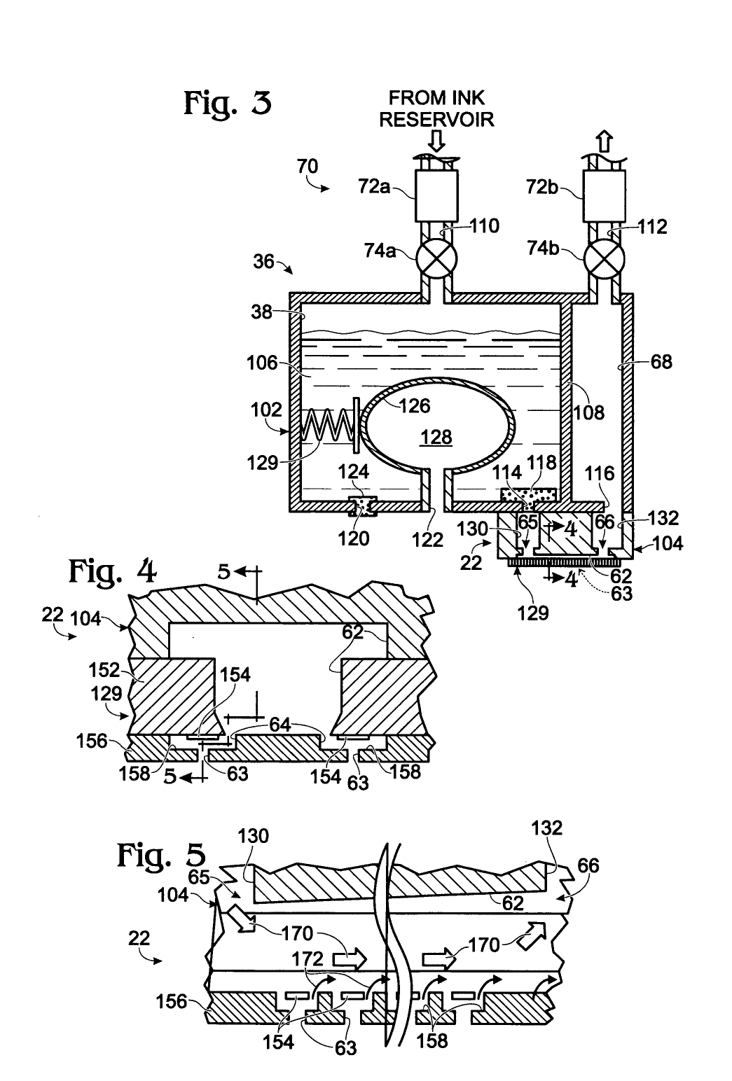

FIG. 3 shows a sectional view of selected aspects of printhead assembly 36 and flow controller 70 from printer 20. Printhead assembly may include a body 102 and at least one printhead connected to the body.

Body 102 may define one or more compartments for holding fluid, such as ink or air. For example, in the present illustration, body 102 defines a supply chamber 38 configured to hold ink 106 to be fired from the printhead. Body 102 also may define a receiver compartment 68 separated from supply chamber 38 by internal wall 108. The body may be formed of any suitable material, such as a plastic, metal, glass, or ceramic, among others.

Body 102 may define a plurality of channels for movement of ink into and through the body and/or for regulating pressure in the body. For example, body 102 may define body channels 110, 112 for supplying ink to the body and facilitating ink flow between supply chamber 38 and receiver compartment 68. First body channel 110 may function as an inlet channel to receive ink from an ink reservoir. Second body channel 112 may function as an outlet channel for ink and/or gas. Each of body channels 110, 112, respectively, may be regulated by a pump 72a, 72b and/or at least one valve 74a, 74b. In some examples, valve 74a may be a body valve that controls fluid communication between the pump and the supply chamber and valve 74b may a purge valve that controls fluid communication between the pump and a position downstream of the supply chamber and printhead. Each pump may be operable to create a positive or negative pressure in the body relative to the ambient pressure. Alternatively, a single pump may be used.

Body 102 also may define first and second openings 114, 116. First opening 114 may be a chamber outlet to permit ink to flow to printhead 22 and/or to flow to receiver compartment 68 from supply chamber 38. First opening 114 may be covered by a filter 118 to remove particulates from the ink before the ink flows to the printhead. Second opening 116 may be an inlet for receiver compartment 68, to permit ink and/or gas to travel into the receiver compartment. In some embodiments, second opening 116 may function as an inlet to carry ink to printhead 22 and/or supply chamber 38 from receiver compartment 68.

Body also may define an intake orifice 120 and a diaphragm orifice 122. Intake orifice 120 may be covered by a bubbler screen 124 configured to adjust the body pressure by permitting passage of external air into the body if the body pressure becomes too negative. Diaphragm orifice 122 may be attached to a diaphragm or deformable member 126 that forms an external gas compartment 128 of variable volume. Deformable member 126 may function, for example, in conjunction with a biasing member (not shown in diagram), such as a spring 129, to maintain a more constant pressure in supply chamber 38 as ink is removed from the supply chamber. The spring enables a negative pressure to be maintained in the supply chamber throughout a range of temperature or pressure excursions in the ambient environment.

Printhead may include a carrier 104 that provides fluid communication between body 102 and an ejection portion 129 of the printhead. Carrier 104 may define channels 130, 132 that extend between ejection portion 129 and body 102 of the printhead assembly. In some examples, first channel 130 may function as an inlet to carry ink toward the ejection portion, and second channel 132 may function as an outlet to carry ink and/or gas away from the ejection portion to receiver compartment 68. Ink flow between these first and second channels may be encouraged or discouraged according to the open or closed status of purge valve 74b and/or the pressure difference between the channels produced by pump(s) 72a and/or 72b. Carrier 104 may be formed of any suitable material, including ceramic, glass, plastic, silicon, metal, and/or the like.

The printhead may define a supply conduit 62 in fluid communication with the nozzles/orifices 63 of the printhead and providing fluid communication between channels 130, 132. Accordingly, ink entering supply conduit 62 from first channel 130 via inlet 65 may be expelled from the nozzles and/or may travel to second channel 132 via outlet 66. In some embodiments, the supply conduits may be a plurality of distinct conduits, for example, one or more distinct conduits for each column of nozzles.

FIG. 4 shows a sectional view of printhead 22. In this example, carrier 104 and ejection portion 129 cooperatively define supply conduit 62. Supply conduit 62 may extend lengthwise along the printhead, according to the arrangement of the orifices. In the present illustration, orifices 63 are arranged in a pair of adjacent columns.

Ejection portion 129 may include a substrate 152, firing elements 154 formed on or in the substrate, and an orifice plate 156 connected to the substrate. The orifice layer and substrate may define a plurality of passages 64 and/or firing compartments 158 each including a firing element 154, such as a heater element or a piezoelectric element, that can be selectively energized to expel ink from its respective orifice. The substrate may be any suitable material, particularly a semiconductor, such as silicon, or an insulator, such as ceramic or glass.

FIG. 5 shows another sectional view of printhead 22, taken through a column of nozzles 63. To simplify the presentation, a relatively small number of nozzles are shown. However, the printhead may have any suitable number of nozzles. In exemplary embodiments, each column of nozzles may have 150, 300, or 650 orifices.

FIG. 5 indicates a flow path 170 (open arrows) of ink through supply conduit 62. Ink may enter supply conduit 62 from first passage 130 via inlet 65 and exit the supply conduit at second passage 132 via outlet 66. However, action of the flow controller (such as a pump) and/or flow of fluid through the supply conduit may create a pressure drop, shown at 172, directed inwardly across orifices 63. This pressure drop may tend to draw air inward through the orifices, if not sealed first, reducing or replacing a desired movement of ink along the supply conduit. In some examples, the flow controller and/or pump may have a limited flow rate capability, and thus cannot induce a pressure drop high enough through the nozzles to make this path the one of highest resistance. Accordingly, a seal on the nozzles to block the flow of air into printheads may reduce or eliminate this problem.

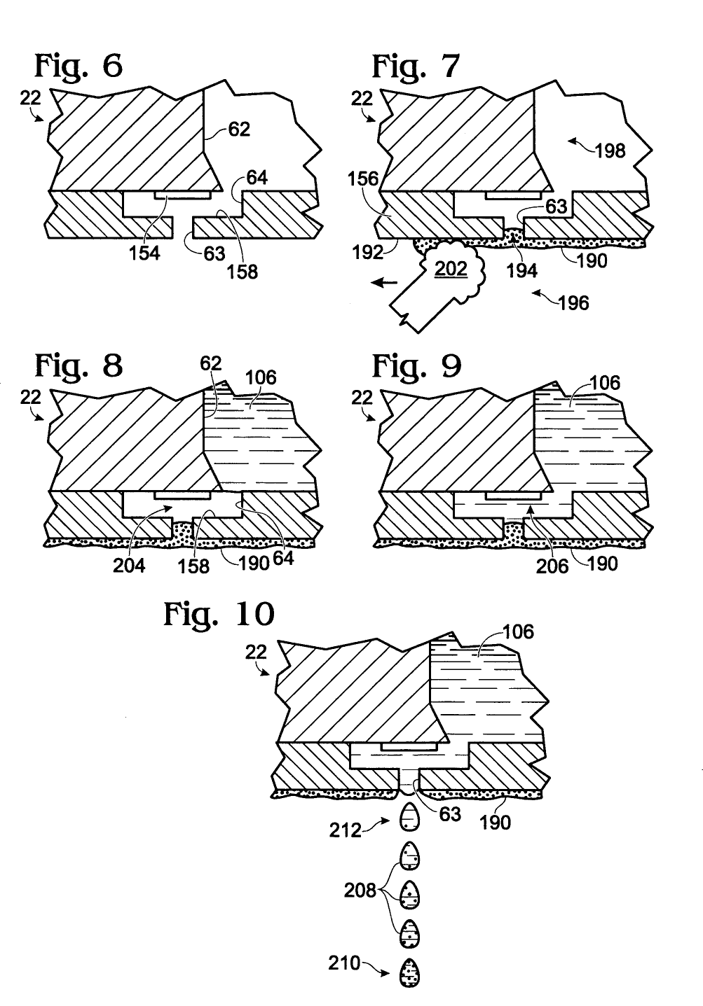

FIGS. 6-10 show printhead configurations produced during performance of a method of removing gas from printhead 22. For simplification, only a single nozzle 63 and firing compartment 158 are shown in fluid communication with supply conduit 62.

FIG. 6 shows printhead 22 in an unprimed configuration. In this unprimed configuration, supply conduit 62 may include or be substantially or completely filled with gas, generally air. Passages 64, firing compartments 158, and/or nozzles 63 also may include or be substantially filled with gas. This unprimed configuration may be the configuration of the printhead before its first use, that is, as sold to consumers. Alternatively, this unprimed configuration may be produced after the printhead has been idle, for example, produced by evaporation or gradual movement of ink or growth of air by diffusion.

FIG. 7 shows printhead 22 during application of a sealing material 190 to an external surface 192 of the printhead. In some examples, external surface 192 may be defined by orifice plate 156. The sealing material may be applied to external surface 192 so that the sealing material covers and seals some or all of orifices 63 of the printhead, shown at 194. Sealing an orifice, as used herein, means that the sealing material restricts passage of fluid through the orifice, for example, passage of external gas 196 into the printhead. Accordingly, a sealed orifice provides a hermetic restriction that separates internal gas 198 from external gas 196. Sealing material 190 may be a fluid applied by contact of the printhead with an applicator 202, such as a wiper. In some examples, the fluid may be applied during a plurality of strokes of the applicator, such as two, three, or more strokes. The applicator may be absorbent or nonabsorbent. In some examples, the applicator may include an elastomeric material, such as ethylene propylene diene monomer (EPDM) rubber.

FIG. 8 shows printhead 22 after movement of ink 106 through supply conduit 62 with sealing material 190 sealing the orifices. The sealing material restricts flow of air through the orifices from outside the printhead, thereby using the pressure drop along the supply conduit to move ink, rather than bringing additional air into the printhead from outside the printhead. In the present illustration, firing compartments 158 and/or passages 64 may include trapped gas 204.

FIG. 9 shows printhead 22 in a primed condition after the trapped gas in the passages and/or firing compartments has been replaced substantially by ink 106, shown at 206. The trapped gas may be displaced by flow of ink from the supply conduit into the passages and/or firing compartments, such as by capillary action. Alternatively, or in addition, the trapped gas may be expelled by firing the firing elements. Sealing material 190 now may be removed to allow proper operation of the primed printhead.

FIG. 10 shows printhead 22 firing droplets 208 from orifice 63. Such droplets initially may include a substantial amount of sealing material 190, shown at 210, which may decrease as additional droplets are fired, shown at 212. Alternatively, or in addition, sealing material may be removed from printhead 22 by a mechanical approach, such as wiping off the sealing material, and/or may be washed off by external application of a suitable solvent. In some examples, firing the droplets from the orifice also may remove trapped gas and/or air bubbles from the passages and/or firing compartments.

It is believed that the disclosure set forth above encompasses multiple distinct embodiments of the invention. While each of these embodiments has been disclosed in specific form, the specific embodiments thereof as disclosed and illustrated herein are not to be considered in a limiting sense as numerous variations are possible. The subject matter of this disclosure thus includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

1. A method of removing gas from a printhead that includes a plurality of orifices configured to receive ink from a supply conduit through passages extending from the supply conduit to the plurality of orifices, the method comprising:
sealing the plurality of orifices from external the printhead to restrict passage of fluid through the orifices; and
moving ink along the supply conduit and through an outlet of the supply conduit disposed downstream of the passages, with the plurality of orifices sealed, so that ink displaces gas from the supply conduit.

2. The method of claim 1, wherein sealing includes applying a sealing material in liquid form to the orifices from external the printhead.

3. The method of claim 2, wherein sealing includes applying a sealing material with a surface tension sufficient to restrict entry of air through the plurality of orifices when ink is moved along the supply conduit.

4. The method of claim 1, wherein the printhead travels between a print zone and a service zone, and wherein sealing is performed with the printhead disposed in the service zone.

5. The method of claim 1, wherein sealing and moving are performed to prime the printhead before the printhead is used a first time for printing onto media.

6. The method of claim 1, wherein sealing and moving are initiated after a predefined idle time during which the printhead does not expel ink from the plurality of orifices.

7. The method of claim 6, wherein sealing and moving are initiated automatically upon receipt of a print command.

8. The method of claim 1, wherein the printhead includes a firing mechanism that ejects ink from the plurality of orifices, and wherein sealing including applying a sealing material, the method further comprising operating the firing mechanism to remove the sealing material from the plurality of orifices.

9. The method of claim 8, wherein the printhead travels between a print zone and a service zone, and wherein operating the firing mechanism is performed with the printhead disposed in the service zone.

10. The method of claim 1, wherein sealing includes placing adjacent the orifices one or more materials selected from a group consisting of water, ink, dipropylene glycol, ethylene glycol, propylene glycol, and polyethylene glycol.

11. The method of claim 1, wherein moving includes operating a peristaltic pump.

12. A printing device, comprising:
a printhead including a plurality of orifices and a supply conduit with an outlet and further including a plurality of passages disposed upstream of the outlet and extending from the supply conduit to the plurality of orifices;
a sealing mechanism configured to seal the plurality of orifices from external the printhead so that passage of fluid through the orifices is restricted; and
a flow controller configured to move ink along the supply conduit and through the outlet, with the plurality of orifices sealed, such that ink displaces gas from the supply conduit.

13. The printing device of claim 12, wherein the sealing mechanism includes an applicator configured to apply a sealing material from external the printhead.

14. The printing device of claim 13, wherein the applicator applies the sealing material through contact between the applicator and the printhead.

15. The printing device of claim 12, wherein the printhead travels between a print zone and a service zone, and wherein the sealing mechanism is configured to seal the plurality orifices with the printhead disposed in the service zone.

16. The printing device of claim 12, wherein the flow controller includes a peristaltic pump.

17. The printing device of claim 12, further comprising a processor in communication with the flow controller, wherein the processor is configured to initiate operation of the flow controller.

18. The printing device of claim 17, wherein the processor is configured to initiate operation of the sealing mechanism.

19. A program storage device readable by a processor, tangibly embodying a program of instructions executable by the processor to perform methods steps for removing gas from a printhead that includes a plurality of orifices configured to receive ink from a supply conduit through passages extending from the supply conduit to the plurality of orifices, the method steps comprising:
sealing the plurality of orifices from external the printhead to restrict passage of fluid through the orifices; and
moving ink along the conduit and through an outlet of the supply conduit disposed downstream of the passages, with the plurality of orifices sealed, so that ink displaces gas from the supply conduit.

20. The program storage device of claim 19, wherein sealing and moving are initiated after a predefined idle time during which the printhead does not expel ink from the plurality of orifices.

21. A printing device, comprising:
a printhead including a plurality of orifices and a supply conduit with an outlet and further including a plurality of passages disposed upstream of the outlet and extending from the supply conduit to the plurality of orifices;
a means for sealing the plurality of orifices from external the printhead so that passage of fluid through the orifices is restricted; and
a means for moving ink along the supply conduit and through the outlet, with the plurality of orifices sealed, such that ink displaces gas from the supply conduit.
